(19) United States
(12) Patent Application Publication
(10) Pub. No.: US 2015/0035198 A1
(43) Pub. Date: Feb. 5, 2015

(54) SYSTEMS AND METHODS FOR THREE-DIMENSIONAL PRINTING

(71) Applicant: Simon Saba, San Jose, CA (US)

(72) Inventor: Simon Saba, San Jose, CA (US)

(21) Appl. No.: 14/446,223

(22) Filed: Jul. 29, 2014

Related U.S. Application Data
(60) Provisional application No. 61/860,884, filed on Jul. 31, 2013.

(51) Int. Cl. B29C 47/04

(52) U.S. Cl. CPC B29C 47/04
USPC 264/211.12; 425/131.1

(57) ABSTRACT

A system and method for controlling filament extrusion comprises receiving extrusion path signals that specify a first extrusion path and a second extrusion path for simultaneous execution by a corresponding first print head and second print head, and simultaneously extruding a first filament from the first print head according to the first extrusion path and a first extrusion rate specification, and a second filament from the second print head according to the second extrusion path and a second extrusion rate specification. The first extrusion path and the second extrusion path are specified according to a target coordinate space. In one embodiment, the target coordinate space comprises a cylindrical coordinate space. The system and method advantageously provides faster printing and greater material flexibility for three-dimensional printers.

### CROSS-REFERENCE TO RELATED APPLICATIONS

The present application claims priority to U.S. Provisional Application No. 61/860,884, titled “3D Printer,” filed Jul. 31, 2013, which is hereby incorporated by reference in its entirety.

### FIELD OF THE INVENTION

Embodiments of the present invention relate generally to three-dimensional (3D) printing, and more specifically to systems and methods for 3D printing.

### BACKGROUND

A typical 3D printer is an electro-mechanical machine designed to fabricate a physical 3D object by stacking sequential layers of material. Each layer of material is defined by a two-dimensional (2D) geometry, and a complete stack of layers forms a 3D approximation of the 3D object. Extrusion printers are 3D printers comprising a print head configured to extrude a filament of material and a print stage. The print head is displaced relative to the print stage by a set of mechanical actuators to scan the geometric extent of each layer while the print head extrudes material filling the geometry of each layer. The mechanical actuators are conventionally configured to provide X, Y, and Z displacements within a Cartesian coordinate space. Displacement within the X and Y dimensions are conventionally implemented as an X-Y actuator assembly that moves the print head, while displacement within the Z dimension is implemented by moving the X-Y actuator assembly up or down relative to the print head. When one layer is complete, displacement in the Z dimension is increased by one unit of layer thickness and a new layer is extruded on top of a previous layer.

To provide appropriate spatial resolution in the final printed 3D object, the extruded filament is typically quite thin relative to the 3D object. In typical 3D printers, the X, Y, and Z movements of the print head are limited in velocity and therefore material deposition from extrusion is similarly limited. Limitations in material deposition rates translate directly to the length of time needed to complete printing the 3D object. As such, deposition rate is a key system limitation for overall efficiency and throughput of 3D printing systems. Larger filaments may be deposited to increase deposition rates, but at the cost of a potentially unacceptable loss of resolution. In practice, with typical resolution requirements, even small objects can take hours to print and larger objects can take days to print. Such lengthy print times reduce the usefulness and applicability of 3D printing in general. In certain scenarios, two or more different filament materials need to be printed together within the same 3D object. Conventional 3D printers require assistance from a human operator to change filament material during the printing process, further limiting efficiency.

As the foregoing illustrates, there is a need for addressing this and/or other related issues associated with the prior art.

### SUMMARY

A system and method for controlling filament extrusion is disclosed. The method comprises receiving extrusion path signals that specify a first extrusion path and a second extrusion path for simultaneous execution by a corresponding first print head and second print head, and simultaneously extruding a first filament from the first print head according to the first extrusion path and a first extrusion rate specification, and a second filament from the second print head according to the second extrusion path and a second extrusion rate specification. The first extrusion path and the second extrusion path are specified according to a target coordinate space. In one embodiment, the target coordinate space comprises a cylindrical coordinate space.

The system and method advantageously provides faster printing and greater material flexibility for three-dimensional printers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a flow chart of a first method for controlling filament extrusion in a 3D printer, in accordance with one embodiment;

FIG. 1B illustrates a flow chart of a second method for controlling filament extrusion in a 3D printer, in accordance with one embodiment;

FIG. 1C illustrates a flow chart of a method for controlling filament extrusion in a multi-line extrusion print head, in accordance with one embodiment;

FIG. 1D illustrates a flow chart of a method for controlling filament extrusion in a multi-color extrusion print head, in accordance with one embodiment;

FIG. 2A illustrates an exemplary 3D object to be printed;

FIG. 2B illustrates a layer of the 3D object;

FIG. 2C illustrates an extrusion path for printing a layer associated with the 3D object using a Cartesian coordinate system;

FIG. 2D illustrates a printed layer of the 3D object;

FIG. 2E illustrates extrusion paths for printing a layer associated with the 3D object using cylindrical coordinates, according to one embodiment of the present invention;

FIG. 2F illustrates a printed layer of the 3D object, according to one embodiment of the present invention;

FIG. 3A illustrates a 3D printer, configured to implement one or more aspects of the present invention;

FIG. 3B illustrates a 3D printer, configured to operate within a cylindrical enclosure, according to one embodiment of the present invention;

FIG. 3C illustrates a 3D printer, configured to include two simultaneously-operating print heads, according to one embodiment of the present invention;

FIG. 3D illustrates air flow within a cylindrical enclosure for a 3D printer, according to one embodiment of the present invention;

FIG. 4A illustrates a linear track configured to accommodate two print heads that move along a common travel path, in accordance with one embodiment;

FIG. 4B illustrates a linear track configured to accommodate two print heads that move along independent travel paths, in accordance with one embodiment;

FIG. 4C illustrates a print head platform configured to include one linear track and two print heads, in accordance with one embodiment;

FIG. 4D illustrates a print head platform configured to include one linear track and four print heads, in accordance with one embodiment;

FIG. 4E illustrates a print head platform configured to include four linear tracks and four print heads, in accordance with one embodiment;

FIG. 4F illustrates a print head platform configured to include four linear tracks and eight print heads, in accordance with one embodiment;

FIG. 4G illustrates a print head platform configured to include eight linear tracks and eight print heads, in accordance with one embodiment;

FIG. 5A illustrates a print head platform configured to include four linear tracks and eight print heads configured to be moved by associated stepper motors, in accordance with one embodiment;

FIG. 5B illustrates a stage platform coupled to a print head platform, in accordance with one embodiment;

FIG. 6A illustrates an extruder assembly comprising a print head, in accordance with one embodiment;

FIG. 6B illustrates a top view of a circular heating element included in the extruder assembly of FIG. 6A, in accordance with one embodiment;

FIG. 6C illustrates a side view of the circular heating element comprising the extruder assembly, in accordance with one embodiment;

FIG. 6D illustrates a top view of a heat sink comprising the extruder assembly, in accordance with one embodiment;

FIG. 6E illustrates a side view of a heat sink comprising the extruder assembly, in accordance with one embodiment;

FIG. 7A illustrates an extrusion path of constant radial distance, in accordance with one embodiment;

FIG. 7B illustrates an extruded filament along an extrusion path of constant radial distance, in accordance with one embodiment;

FIG. 7C illustrates extrusion paths for different extruded filament sizes along corresponding paths of constant radial distance, in accordance with one embodiment;

FIG. 7D illustrates extruded filaments of different extruded filament sizes along extrusion paths of constant radial distance, in accordance with one embodiment;

FIG. 7E illustrates a multi-line extrusion nozzle in different angular positions, in accordance with one embodiment;

FIG. 7F illustrates an extruded filament along a linear extrusion path, in accordance with one embodiment;

FIG. 8 illustrates a color extruder assembly comprising a color extrusion head, in accordance with one embodiment, in accordance with one embodiment; and

FIG. 9 illustrates a printed layer comprising three different filament materials, in accordance with one embodiment.

### DETAILED DESCRIPTION

Embodiments of the present invention enable improved 3D printing efficiency and system flexibility. Certain embodiments comprise mechanical actuators configured to provide print head movement within a cylindrical coordinate system. A print stage is configured to rotate through a stage angle, providing a cylindrical coordinate angle dimension. A print head platform is configured to move along a height axis relative to the print stage to provide a cylindrical coordinate height dimension. One or more print heads are configured to move along linear tracks that are coupled to the print head platform to provide corresponding cylindrical coordinate radius dimensions. Each print head is configured to selectively extrude filament material at a specified extrusion rate, which may vary over a given extrusion path. In certain configurations, a rotational origin associated with the print stage is offset relative to an effective radial origin associated with the linear tracks. One or more print heads may be configured to operate along each linear track. Two or more print heads may be configured to move and extrude filament material simultaneously without interfering with each other, thereby reducing overall print time associated with fabricating a finished 3D object. An extrusion rate function for each of two or more different print heads is determined according to an extrusion path for each print head. Different filament materials may be fed into each of two or more different print heads for simultaneous extrusion. Different materials may include different colors, different types of materials, and the like. Two or more different print heads may be fed with the same type of filament material.

In certain configurations, one print head may be configured to extrude material having a different size than a second print head. For example, a first print head may be configured to extrude filament material having a diameter of one tenth of a millimeter, while a second print head may be configured to extrude filament material having a diameter of one millimeter. In such a configuration, the second print head may be used to print bulk shapes, which may cross several layers, and the first print head may be used to print fine detail according to spatial resolution requirements of the 3D object.

A color print head is disclosed that provides a continuous color range of extruded filament material. In one embodiment, the color print head is fed four different filaments with corresponding colors of white, cyan, magenta, and yellow. A feed rate of each different filament color determines extruded filament color. The print head includes a mixing chamber where filament material for each of the four different filaments is mixed to produce a properly colored filament material for extrusion. In certain embodiments, a fifth filament having a color of black is also fed into the print head to provide potentially deeper shades of black than available by simply mixing cyan, magenta, and yellow.

A 3D printer configured to implement cylindrical coordinates may be configured to operate within a cylindrical enclosure, which may provide certain benefits with respect to thermal management.

In one embodiment, an effective radius defines a distance along a travel path of a print head. The travel path may not intersect the rotational origin, and in such configurations an offset from the rotational origin and the effective radius may be used to calculate an actual radius, which may be defined as the hypotenuse of a right triangle formed by the effective radius and the offset length. An actual rotation angle may be calculated from the effective radius, the offset, and the rotation angle. Extrusion path information may account for the offset, or the 3D printer may compute actual radius and actual rotation angle values based on extrusion path information.

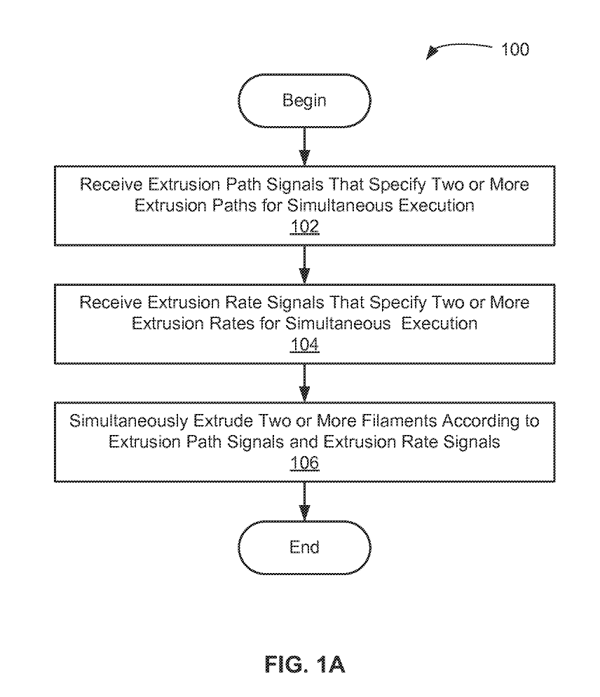

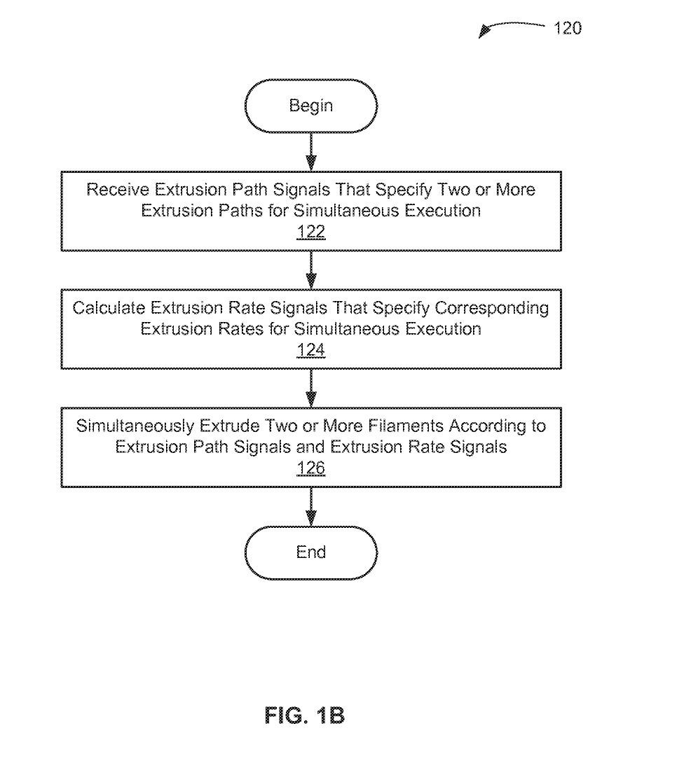

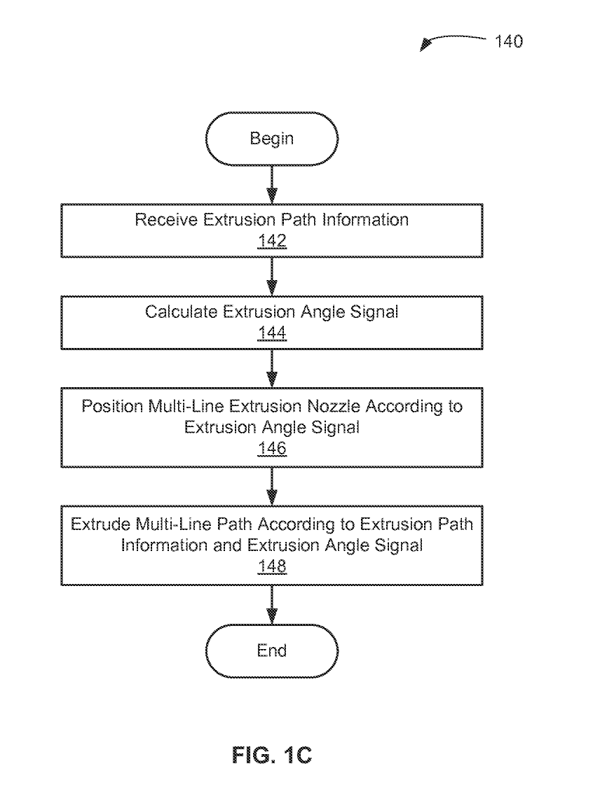

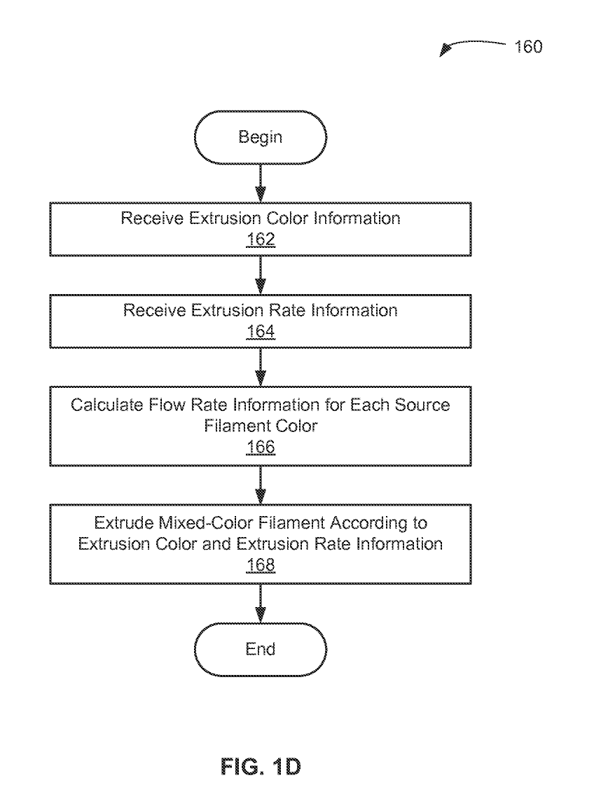

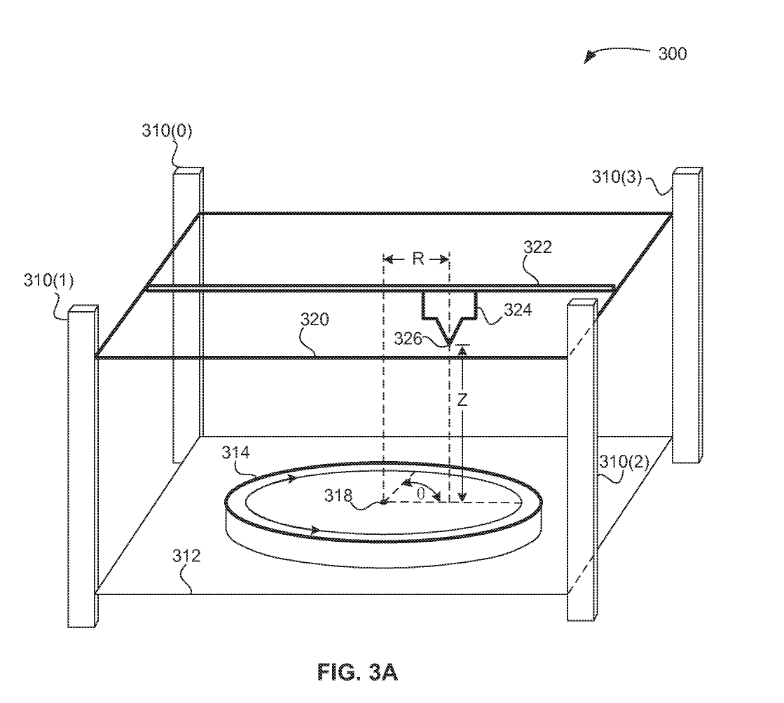

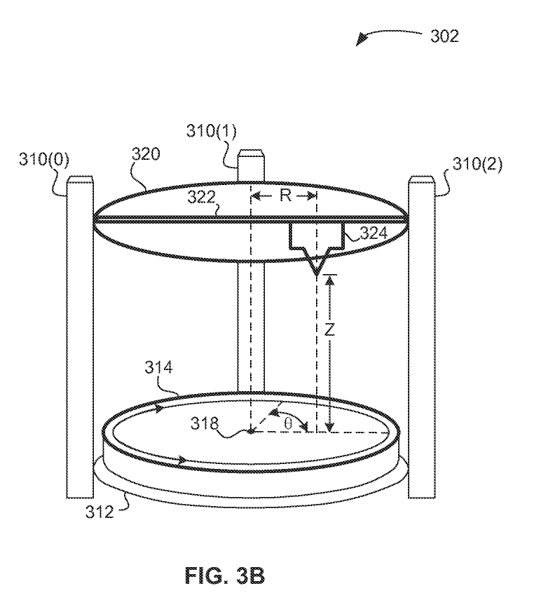

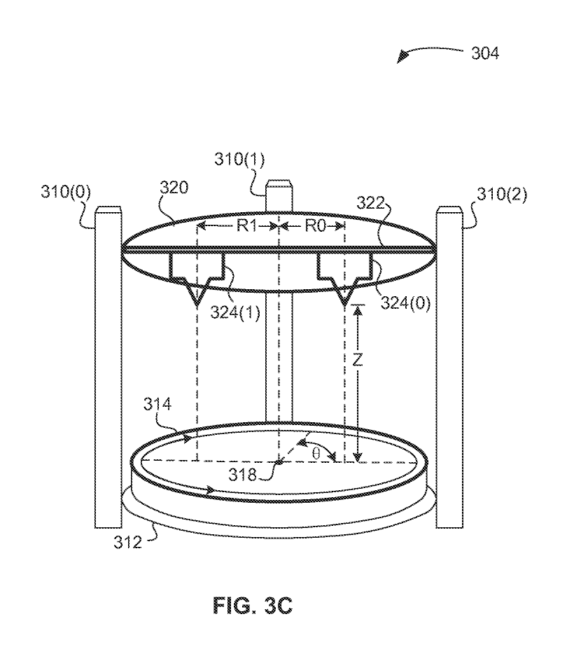

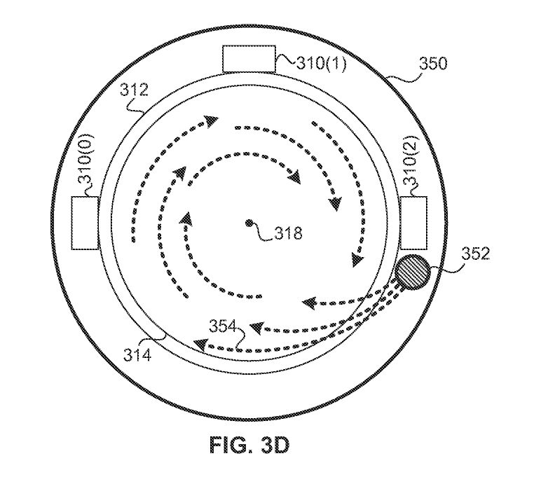

FIG. 1A illustrates a flow chart of a first method 100 for controlling filament extrusion in a 3D printer, in accordance with one embodiment. Although method 100 is described in conjunction with the systems of FIGS. 3A-6E, and 8, persons of ordinary skill in the art will understand that any system that performs method 100 is within the scope and spirit of embodiments of the present invention. In one embodiment, a 3D printer, such as 3D printer 304 of FIG. 3C, is configured to perform method 100.

Method 100 directs a 3D printer configured to include multiple print heads to more quickly deposit a given print layer by enlisting two or more print heads to simultaneously deposit filament material within the print layer. In one embodiment, the print heads operate within a cylindrical coordinate space, allowing each print head to advantageously move relatively freely without colliding or otherwise interfering with any other print head.

Method 100 begins at step 102, where the 3D printer receives extrusion path signals that specify two or more extrusion paths for simultaneous execution by corresponding print heads. Each extrusion path defines a sequence of locations within a target coordinate space for a print head to visit and selectively extrude filament material at a specified extrusion rate along the extrusion path. The extrusion path signals may be encoded using any technically feasible technique.

In one embodiment, the extrusion path signals comprise a sequence of digitally encoded location information and corresponding time information. The location information and time information may be scaled or otherwise translated according to requirements of a specific implementation. The 3D printer may implement any technically feasible buffering technique to receive an arbitrary set of extrusion path signals in advance of executing the extrusion path signals. In another embodiment, the extrusion path signals comprise control signals that directly control operation of various actuators within the 3D printer. The actuators may be, e.g., alternating current (AC) motors, direct current (DC) motors, stepper motors, hydraulic or pneumatic actuators, linear actuators, and the like.

At step 104, the 3D printer receives extrusion rate signals that specify two or more extrusion rates for simultaneous execution by corresponding print heads. Execution of an extrusion rate signal comprises configuring a print head to cause filament material to be extruded at a rate specified by the extrusion rate signal over a specified span of time or sequence values. Each extrusion rate signal defines a sequence of extrusion rates for a given print head to execute while traversing different locations specified by a corresponding extrusion path. The extrusion rate signals may be encoded using any technically feasible technique.

In one embodiment, the extrusion rate signals comprise a sequence of digitally encoded rate (e.g. flow or velocity) information and corresponding time information. The rate information and time information may be scaled or otherwise translated according to requirements of a specific implementation. The 3D printer may implement any technically feasible buffering technique to receive extrusion rate signals in advance of execution. In another embodiment, the extrusion rate signals comprise control signals that directly control operation of an extrusion mechanism configured to propel filament material through a print head nozzle.

At step 106, the 3D printer simultaneously extrudes two or more filaments according to the extrusion path signals and corresponding extrusion rate signals. Simultaneous extrusion involves two or more print heads simultaneously moving along extrusion paths specified by the extrusion path signals while selectively extruding filament material along the extrusion paths. Such simultaneous operation of the two or more print heads should be synchronized in time, with each extrusion path signal and each extrusion rate signal specified according to a common time signal.

FIG. 1B illustrates a flow chart of a method 120 for controlling filament extrusion in a 3D printer, in accordance with one embodiment. Although method 120 is described in conjunction with the systems of FIGS. 3A-6E, and 8, persons of ordinary skill in the art will understand that any system that performs method 120 is within the scope and spirit of embodiments of the present invention. In one embodiment, a 3D printer 304 of FIG. 3C, is configured to perform method 120.

Method 120 begins at step 122, where the 3D printer receives extrusion path signals that specify two or more extrusion paths for simultaneous execution by corresponding print heads. Step 122 proceeds substantially identically as described above in step 102 of method 100.

At step 124, the 3D printer calculates extrusion rate signals that specify corresponding extrusion rates for simultaneous execution by corresponding print heads. Any technically feasible technique may be implemented to calculate a given extrusion rate signal. In one embodiment, each extrusion path signal comprises movement segments along a specified extrusion path, and each movement segment is specified by a location and time. An extrusion rate signal is calculated according to print head velocity for each segment by calculating distance traveled within the segment divided by the time duration for the segment.

At step 126, the 3D printer simultaneously extrudes two or more filaments according to the extrusion path signals and corresponding calculated extrusion rate signals. Step 126 proceeds substantially identically as described above in step 106 of method 100.

FIG. 1C illustrates a flow chart of a method 140 for controlling filament extrusion in a multi-line extrusion print head, in accordance with one embodiment. Although method 140 is described in conjunction with the systems of FIGS. 3A-6E, and 8, persons of ordinary skill in the art will understand that any system that performs method 140 is within the scope and spirit of embodiments of the present invention. In one embodiment, a 3D printer 304 of FIG. 3C, is configured to perform method 140.

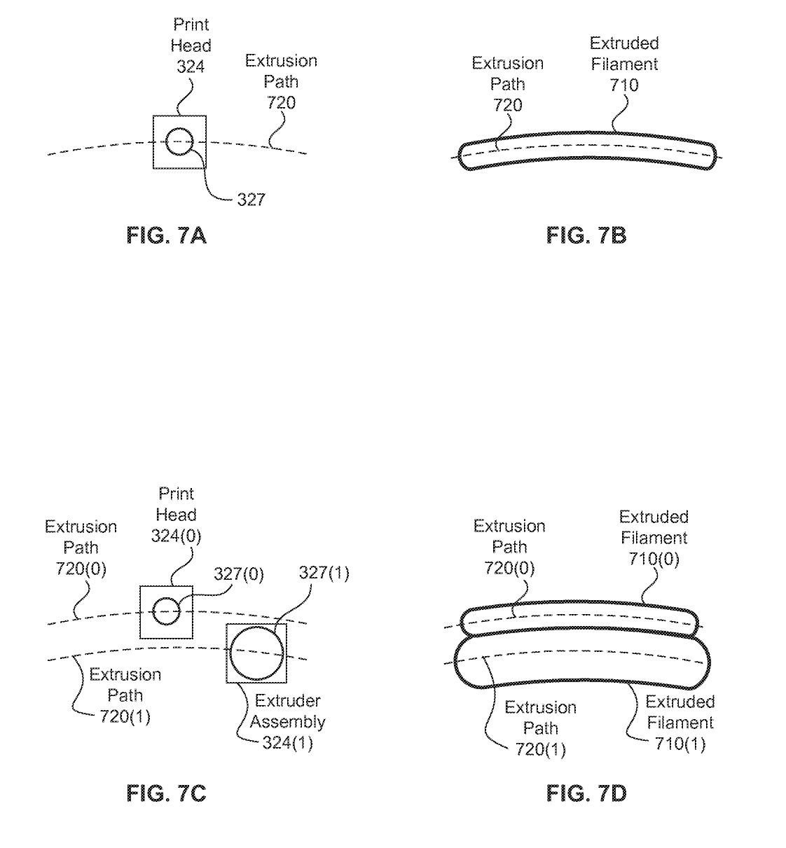

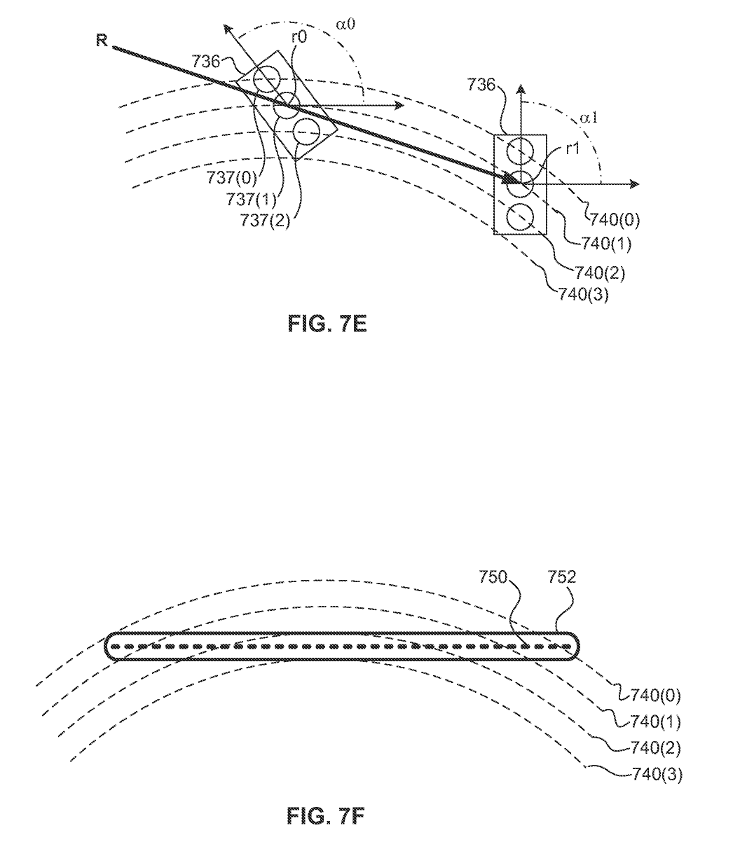

A conventional extrusion nozzle deposits a single line of extruded filament material along a given extrusion path. Method 140 enables a multi-line extrusion nozzle, described below in FIG. 7E, to simultaneously deposit multiple adjacent lines of extruded filament material along corresponding extrusion paths. Each line of extruded filament material deposited by the multi-line extrusion nozzle is consistent in geometry and pitch with respect to single-line (conventional) extrusion nozzles of similar specifications. A multi-line extrusion nozzle advantageously deposits more area within a print layer, thereby reducing print time for the layer and, generally may reduce overall print time for a 3D object.

Method 140 begins at step 142, where the 3D printer receives extrusion path information. In one embodiment, the extrusion path information includes an effective radius coordinate for a portion of extrusion time associated with an extrusion path.

At step 144, the 3D printer calculates an extrusion angle signal based on the extrusion path information. The extrusion angle should be calculated to cause extruded filament material to be deposited without a gap between each line of extruded filament material.

At step 146, the 3D printer positions the multi-line extrusion nozzle according to the calculated extrusion angle signal. At step 148, the 3D printer extrudes filament material along a portion of a multi-line path according to the extrusion path information and the extrusion angle signal.

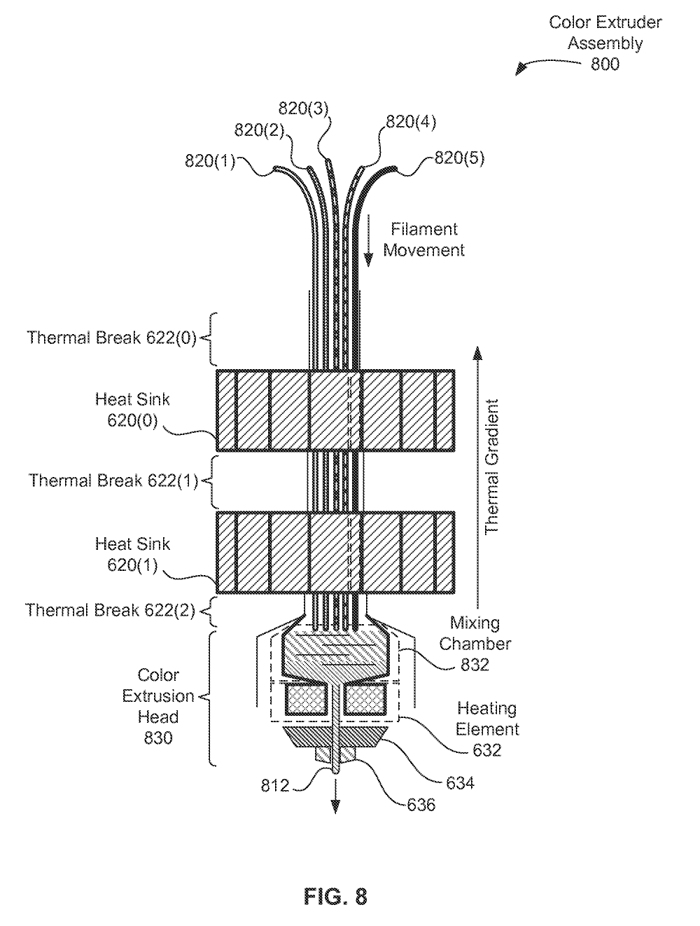

FIG. 1D illustrates a flow chart of a method 160 for controlling filament extrusion in a multi-color extrusion print head, in accordance with one embodiment. Although method 160 is described in conjunction with the systems of FIGS. 3A-4G, 6A-6E, and 8, persons of ordinary skill in the art will understand that any system that performs method 160 is within the scope and spirit of embodiments of the present invention. In one embodiment, a color extruder assembly 800 of FIG. 8, is configured to perform method 160.

Method 160 enables a 3D printer print head to advantageously generate a continuous range of color for extruded filament material by mixing input filaments having a set of available colors, such as cyan, magenta, yellow, white, and black.

Method 160 begins at step 162, where the 3D printer receives extrusion color information. The extrusion color information may be specified in any technically feasible color space, and optionally transformed into a color space associated with available filament colors using any technically feasible color transform technique. In one embodiment, the available filament colors include cyan, magenta, yellow (CMY) colors. The available filament colors may also include white, or a combination of white and black.

At step 164, the 3D printer receives extrusion rate information. In one embodiment, extrusion rate information defines an extrusion rate for mixed color filament material, irrespective of individual flow rates for the different colored input filaments.

At step 166, the 3D printer calculates flow rate information for each source filament color. The flow rate information is calculated to reflect relative contributions of each source filament color and scaled according to the extrusion rate information.

At step 168, the 3D printer print head extrudes a mixed-color filament according to extrusion color information and extrusion rate information.

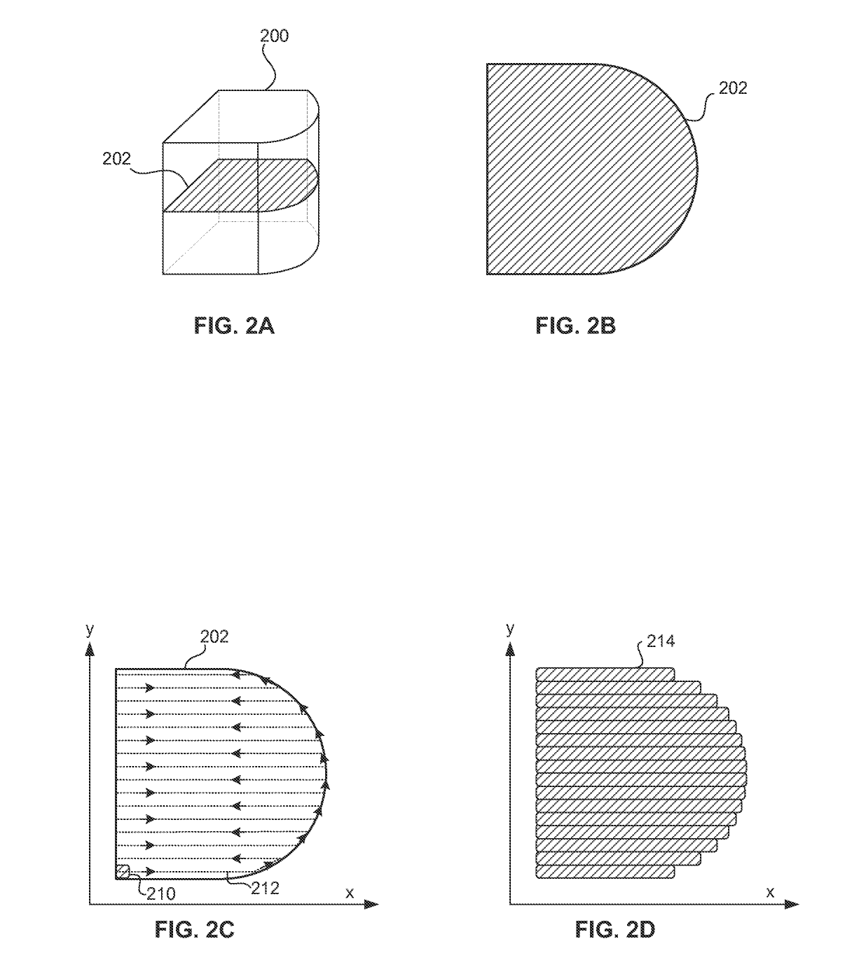

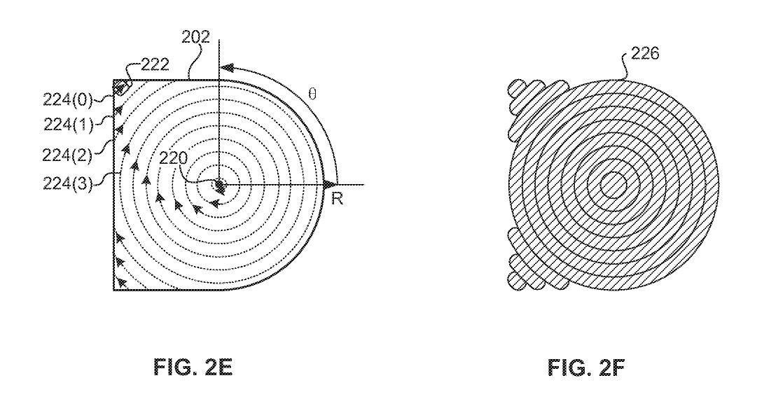

FIG. 2A illustrates an exemplary 3D object 200 to be printed. The 3D object 200 is fabricated as a stack of layers, such as layer 202, with each layer in the stack of layers printed via extrusion to fill geometry for a corresponding intersecting plane of the 3D object 200.

FIG. 2B illustrates a layer 202 of the 3D object 200 of FIG. 2A. The layer comprises a two-dimensional representation of one plane of geometry associated with the 3D object 200.

FIG. 2C illustrates an extrusion path 212 for printing layer 202 associated with the 3D object 200 of FIG. 2A using a Cartesian coordinate system. An extrusion nozzle 210 is swept along the extrusion path 212 to deposit an extruded filament along the extrusion path 212, which is specified to fill all geometry associated with the layer 202.

FIG. 2D illustrates a printed layer 214 of the 3D object 200 of FIG. 2A. Extruded filament material is shown as shaded rectangular regions substantially conforming to the geometry of the layer 202.

FIG. 2E illustrates extrusion paths 224 for printing layer 202 associated with the 3D object 200 of FIG. 2A using cylindrical coordinates, according to one embodiment of the present invention. The cylindrical coordinates include a rotation angle θ for a print stage and a radius value R along a linear path. In one embodiment, the linear path intersects a rotational origin 220. In other embodiments, the linear path does not intersect the rotational origin 220. As shown, extrusion paths 224 follow arcs of constant radius value. In other embodiments, arbitrary paths may be constructed to fill the geometry of layer 202, including one or more linear paths substantially replicating segments of extrusion path 212 of FIG. 2C.

FIG. 2F illustrates a printed layer 226 of the 3D object 200 of FIG. 2A, according to one embodiment of the present invention. Extruded filament material is shown as shaded rectangular regions substantially conforming to the geometry of the layer 202.

FIG. 3A illustrates a 3D printer 300, configured to implement one or more aspects of the present invention. The 3D printer 300 includes a stage platform 312 and a print head platform 320. The stage platform 312 is coupled to a print stage 314 and one or more height actuators 310. The print head platform 320 is also coupled to the height actuators 310, which are configured to provide a variable distance between the stage platform 312 and the print head platform 320. In one embodiment, the print head platform 320 is configured to move up and down with respect to the stage platform 312, thereby varying the distance between the print head platform 320 and stage platform 312. Any technically feasible technique or mechanism may be implemented to vary the distance between the print head platform 320 and stage platform 312. In one embodiment, each height actuator 310 comprises a stepper motor coupled to a helical thread drive screw to provide linear motion along a height axis that is substantially normal to both the stage platform 312 and the print head platform 320. In another embodiment, a linear servo implements linear motion along the height axis. In yet another embodiment, a linear pneumatic actuator provides linear motion along the height axis. In certain embodiments, the print head platform 320 is coupled to a cable, pulley, and motor assembly configured to provide linear motion along the height axis.

In one embodiment, the stage platform 312 and the print head platform 320 are configured to remain substantially parallel over the variable distance.

The print head platform 320 comprises one or more print heads 324 configured to move along a linear track 322. Any technically feasible technique may be implemented to move the print head 324 along linear track 322, including any of the techniques discussed above with respect to the height actuator 310. As the print head 324 moves along the linear track 322, an effective radius value R is established accordingly. The effective radius value R is a measure of linear position along the linear track 322 and may be measured relative to a rotational origin 318, an offset from the rotational origin 318, or any other technically feasible reference.

Each print head 324 includes a nozzle 326, through which filament material is extruded along an extrusion path, such as an extrusion path 224 of FIG. 2E, in the process of depositing a printed layer. A cylindrical coordinate system height dimension, shown as Z, defined herein as an effective deposition height above the top surface of the print stage 314. As the print head platform 320 moves along the height axis, the effective deposition height Z is established accordingly. In one embodiment, R is measured from a geometric center of nozzle 326 to the rotational origin 318.

The print stage 314 is configured to rotate about the rotational origin 318 to provide a cylindrical coordinate system angle dimension shown as θ. Any technically feasible technique may be implemented to rotate the print stage 314 about the rotational origin 318. In one embodiment, the print stage 314 is coupled to a stepper motor through a cable assembly. Rotational motion generated by the stepper motor is coupled to the print stage 314, causing a proportional rotation about θ.

In normal operation, the 3D printer 300 sequentially prints layers of filament material to fabricate a 3D object. For each layer, the print head 324 deposits filament material along a set of one or more extrusion paths to completely fill a two-dimensional geometry associated with a corresponding intersecting plane for the 3D object.

FIG. 3B illustrates a 3D printer 302, configured to operate within a cylindrical enclosure, according to one embodiment of the present invention. As shown, the stage platform 312 and the print head platform 322 are both fabricated within a circular form factor. Each element of the 3D printer 302 performs substantially identically with respect to corresponding elements of 3D printer 300 of FIG. 3A.

FIG. 3C illustrates a 3D printer 304, configured to include two simultaneously-operating print heads 324(0) and 324(1), according to one embodiment of the present invention. Each element of the 3D printer 304 performs substantially identically with respect to corresponding elements of 3D printer 300 of FIG. 3A. In one embodiment, print heads 324(0) and 324(1) are each configured to operate substantially identically to print head 324 of FIG. 3A. In one embodiment, each print head 324(0), 324(1) is configured to operate independently of the other. Print head 324(0) is configured to move to position R0, while print head 324(1) is configured to move to position R1. Furthermore, each print head 324(0), 324(1) may extrude filament material independently and at independent flow rates.

Collision avoidance may be implemented such that each print head 324(0), 324(1) is not scheduled to occupy an overlapping position along linear track 322. In certain embodiments, the availability of two print heads to perform extrusion simultaneously may advantageously reduce completion time for printing a given 3D object by approximately half relative to prior art 3D printers that are limited to one print head.

FIG. 3D illustrates air flow within a cylindrical enclosure 350 for a 3D printer, according to one embodiment of the present invention. In one embodiment, a fan 352 is configured to generate air flow 354 within the cylindrical enclosure 350. The fan 352 may comprise a centrifugal fan, a stack of box fans, or the like. The fan 352 may be coupled to an air filter (not shown) configured to provide ingress filtration of ambient air surrounding the 3D printer. The cylindrical enclosure 350 may advantageously provide greater consistency in airflow that a rectangular enclosure, such as may be used for 3D printer 300 of FIG. 3A. As such, embodiments having a stage platform 312 and a print head platform 320 that conform to cylindrical enclosure 350 may advantageously achieve more consistent thermal properties than a comparable 3D printer constructed according to rectangular form factors. In one embodiment, the fan 352 is configured to direct air flow 354 directly across print stage 314 to cool recently deposited filament material.

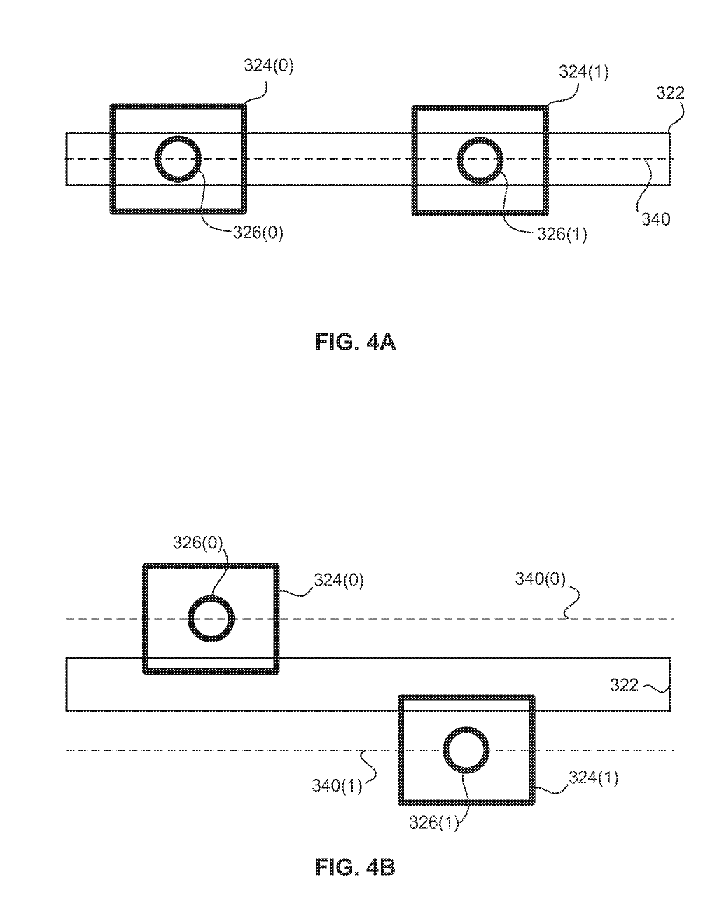

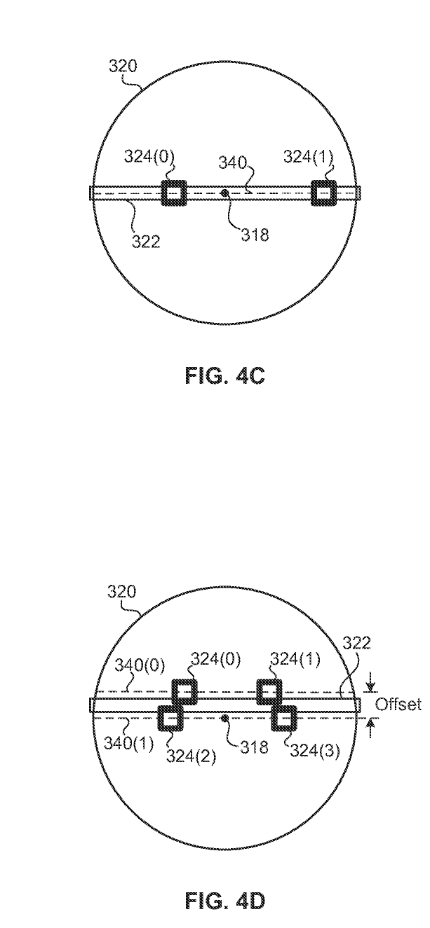

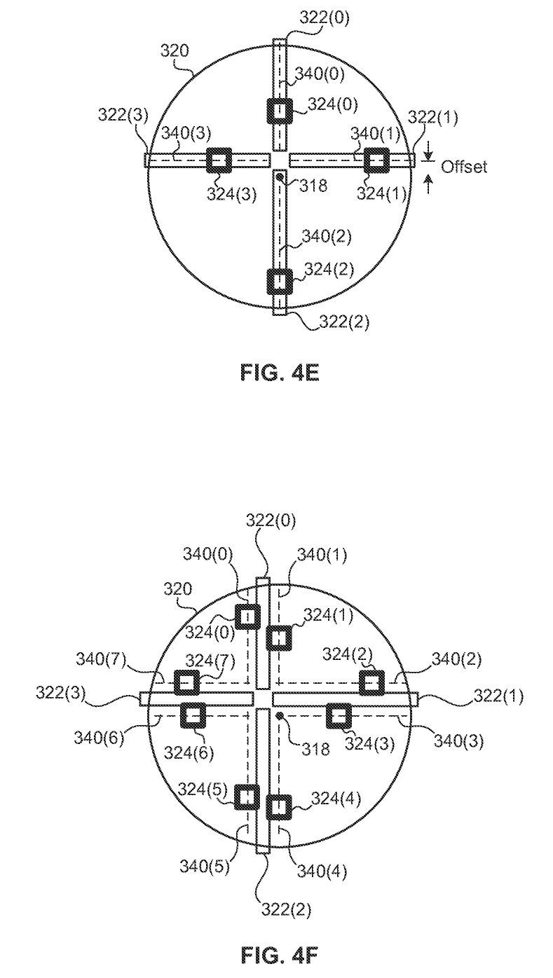

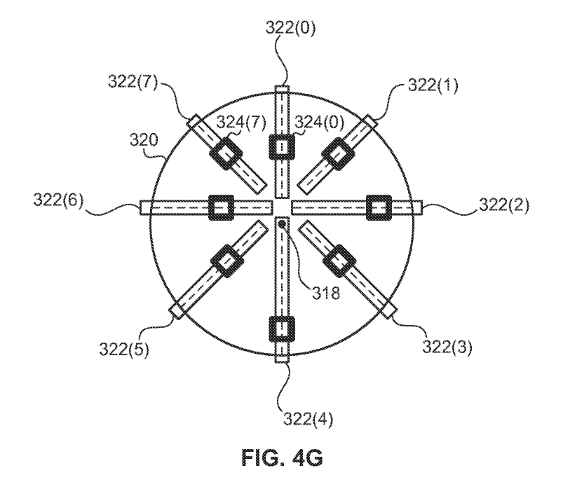

FIG. 4A illustrates a linear track 322 configured to accommodate two print heads 324(0), 324(1) that move along a common travel path, in accordance with one embodiment. As shown, print heads 324(0) and 324(1) may be positioned along travel path 340. Nozzles 326(0) and 326(1) are configured to deposit filament material along travel path 340. As discussed previously, any technically feasible technique may be implemented to move the print heads 324 along linear track 322. Because print heads 324(0) and 324(1) share a common travel path 340, movement of print heads 324(0) and 324(1) should be scheduled to avoid collisions.

FIG. 4B illustrates a linear track 322 configured to accommodate two print heads 324(0), 324(1) that move along independent travel paths 340(0), 340(1), in accordance with one embodiment. As shown, print head 324(0) may be positioned along travel path 340(0), while print head 324(1) is positioned along travel path 340(1). Nozzle 326(0) is configured to deposit filament material along travel path 340(0), while nozzle 326(1) is configured to deposit filament material along travel path 340(1). Any technically feasible technique may be implemented to move the print head 324(0) and 324(1) along linear track 322(0) and 322(1), respectively.

FIG. 4C illustrates a print head platform 320 configured to include one linear track 322 and two print heads 324(0), 324(1), in accordance with one embodiment. A travel path 340 intersects rotational origin 318. As shown, each of the two print heads 324(0), 324(1) may intersect the rotational origin 318 and may deposit filament material along the travel path 340.

FIG. 4D illustrates a print head platform 320 configured to include one linear track 322 and four print heads 324(0)-324(3), in accordance with one embodiment. A travel path 340(1) intersects rotational origin 318, while a travel path 340(0) does not intersect rotational origin 318. Print heads 324(2) and 324(3) are configured to move along travel path 340(1), and are each able to intersect the rotational origin 318. Print heads 324(0) and 324(1) are configured to move along travel path 340(0), and are not able to intersect the rotational origin 318. As a consequence, two-dimensional geometry associated with any layer of a 3D object that covers or is within a specified offset from the rotational origin 318 needs to be deposited with either print head 324(2) or 324(3). Arcs of constant radius may not be centered about rotational origin 318 for print heads 324(0) and 324(1).

Because travel path 340(0) is disposed at an offset from the rotational origin 318, extrusion paths for print heads 324(0) and 324(1) should account for the offset. In one embodiment, extrusion paths for print heads 324(0) and 324(1) are transmitted to the 3D printer as actual radius values and actual rotation values, which are then transformed into effective radius values and effective rotation values, respectively. Such an embodiment advantageously decouples implementation details of the 3D printer from other systems configured to generate the extrusion paths. In another embodiment, extrusion paths for print heads 324(0) and 324(1) are transmitted to the 3D printer as effective radius values and effective rotation values, allowing the 3D printer to proceed without additional processing of the extrusion paths. Such an embodiment, however, requires the other systems to account for implementation-specific offset values.

FIG. 4E illustrates a print head platform 320 configured to include four linear tracks 322(0)-322(3) and four print heads 324(0)-324(3), in accordance with one embodiment. As shown, travel path 340(2) intersects rotational origin 318, enabling print head 324(2) to deposit material within an offset value of the rotational origin 318.

FIG. 4F illustrates a print head platform 320 configured to include four linear tracks 322(0)-322(3) and eight print heads 324(0)-324(7), in accordance with one embodiment. As shown, travel paths 340(3) and 340(4) intersect rotational origin 318, allowing print head 324(3) and 324(4) to deposit filament material at the rotational origin 318 and within an offset value.

FIG. 4G illustrates a print head platform 320 configured to include eight linear tracks 322(0)-322(7) and eight print heads 324(0)-324(7), in accordance with one embodiment.

While FIGS. 4C-4G provide exemplary configurations for print head platform 320, other configurations of a print head platform 320 having a plurality of linear tracks 322 and associated print heads 324 may be implemented without departing from the scope and spirit of embodiments of the present disclosure.

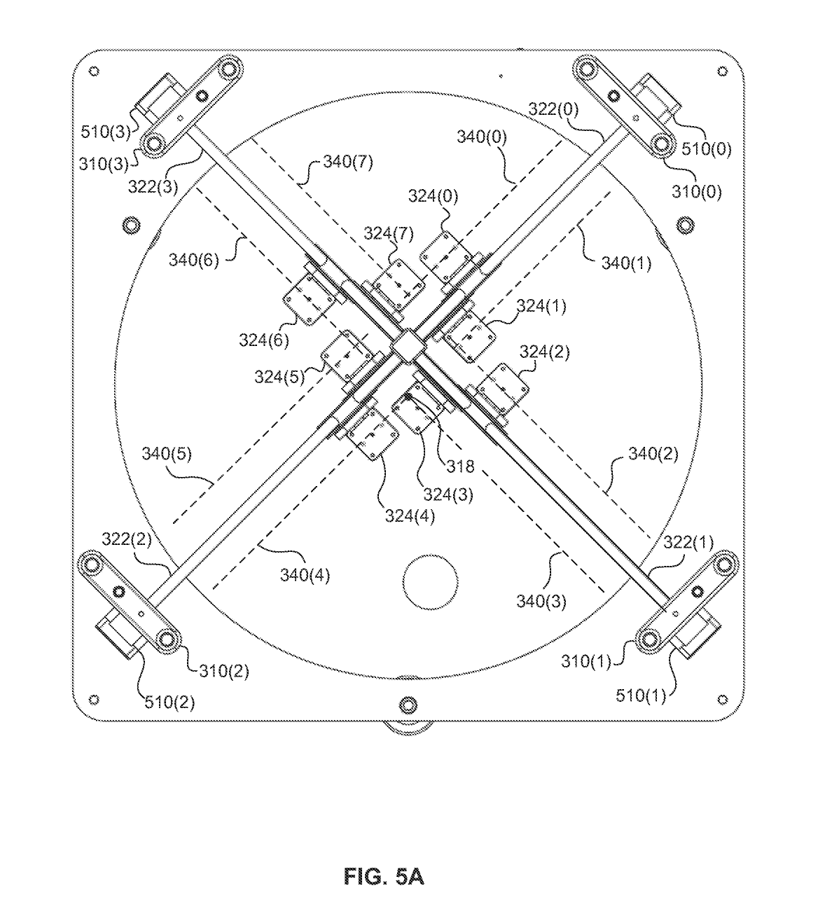

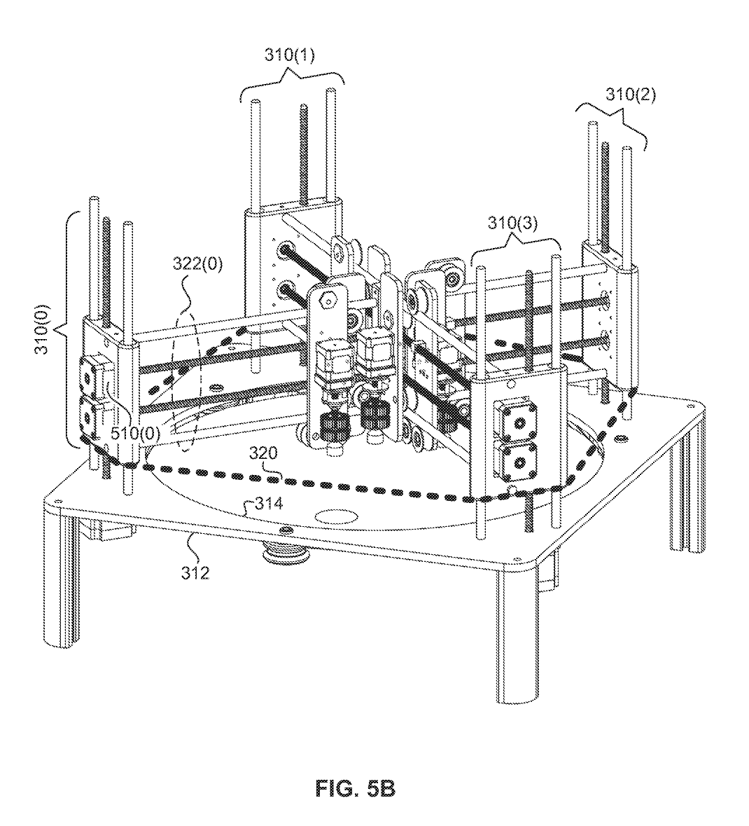

FIG. 5A illustrates a print head platform configured to include four linear tracks and eight print heads configured to be moved by associated stepper motor assemblies 510(0)-510(3), in accordance with one embodiment. Each stepper motor assembly 510(0)-510(3) includes two independently operating stepper motors. For example, stepper motor assembly 510(0) includes a first stepper motor configured to drive movement of print head 324(0) and a second stepper motor configured to drive movement of print head 324(1). The first stepper motor, in conjunction with a first threaded shaft assembly (not shown) within linear track 322(0), forms a first linear actuator configured to move a print head 324(0). The second stepper motor, in conjunction with a second threaded shaft assembly (not shown) within linear track 322(0), forms a second linear actuator configured to move a print head 324(1). Stepper motor assemblies 510(1)-510(3) may be substantially identically constructed and configured to move each respective print head 324.

FIG. 5B illustrates stage platform 312 coupled to print head platform 320, in accordance with one embodiment. In one embodiment, height actuators 310 are configured to position each print head 324 within print head platform 320 to a substantially identical height with respect to print stage 314. In other embodiments, height actuators 310 are configured to operate independently to position associated print heads 324 to operate at different heights with respect to print stage 314. For example, height actuator 310(0) may position linear track 322(0) of print head platform 320 to operate print heads 324(0) and 324(1) at a first height value (Z1), while height actuator 310(1) may position linear track 322(1) to operate print heads 324(2) and 324(3) to operate at a second height value (Z2).

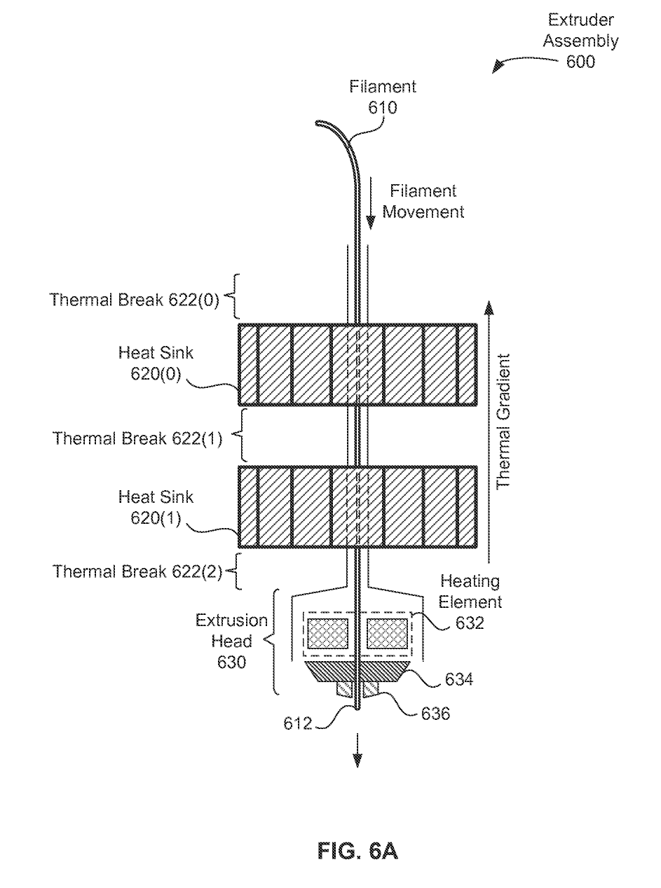

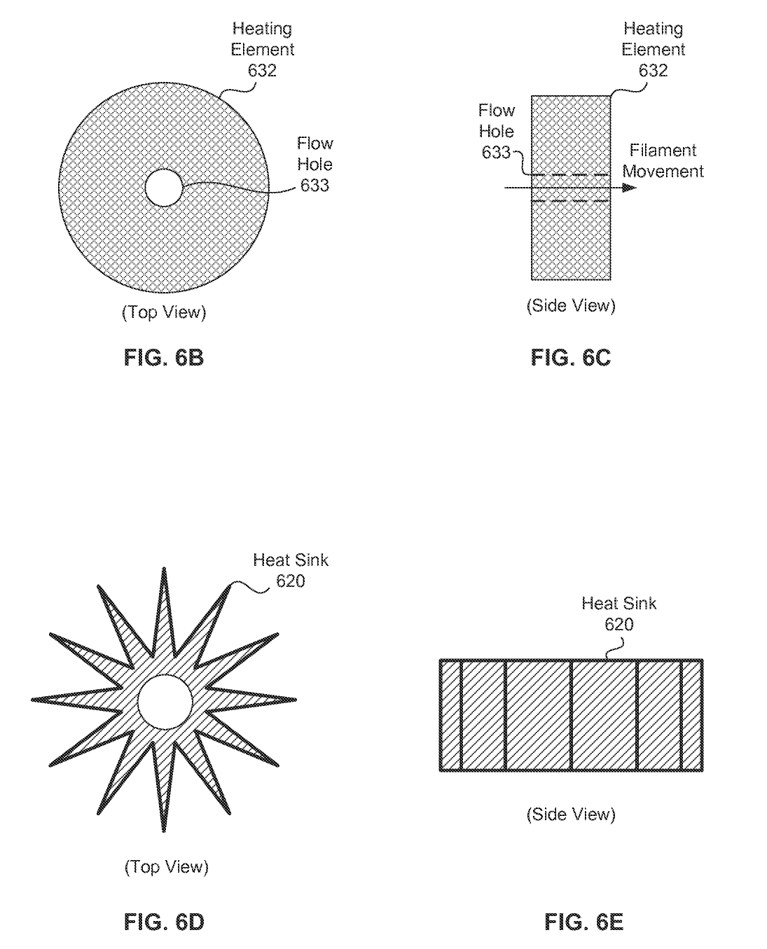

FIG. 6A illustrates an extruder assembly 600 comprising a print head, such as print head 324 of FIG. 3A, in accordance with one embodiment. The extruder assembly 600 includes one or more heat sinks 620 coupled to an extrusion head 630 through a thermal break 622(2). Thermal breaks 622 separate the heat sinks 620 from each other and from other system elements.

In one embodiment, the extrusion head 630 includes a heating element 632, a heat conducting spring washer 634, and a nozzle tip 636. In one embodiment, heating element 632 comprises a circular heating element configured to pass filament material through a flow hole, as illustrated below in FIGS. 6B and 6C. In certain implementations, nozzle tip 636 corresponds to nozzle 326 of FIG. 3A. During deposition, filament 610 is pushed through thermal breaks 622, heat sinks 620, and the extrusion head 630 and forms extruded filament 612. One design goal of extruder assembly 600 is to generate a monotonic thermal gradient that starts with the heating element 632 and declines in the opposite direction of filament movement. In this way, filament 610 remains at substantially ambient temperature and is able to maintain structural integrity while being pushed into the extruder assembly 600, where increasing temperatures ultimately melt the filament 610 for deposition.

FIG. 6B illustrates a top view of a circular heating element 632 included in the extruder assembly 600 of FIG. 6A, in accordance with one embodiment. Heating element 632 is fabricated as a circular solid with a flow hole 633. Uniform heating is provided around filament material passing through the flow hole 633.

FIG. 6C illustrates a side view of the heating element 632 comprising the extruder assembly 600 of FIG. 6A, in accordance with one embodiment.

FIG. 6D illustrates a top view of a heat sink 620 comprising the extruder assembly 600 of FIG. 6A, in accordance with one embodiment. As shown, the heat sink 620 comprises a plurality of cooling fins. In one implementation, the cooling fins should be oriented vertically to facilitate increased convective cooling of the heat sink 620.

FIG. 6E illustrates a side view of the heat sink 620 comprising the extruder assembly 600 of FIG. 6A, in accordance with one embodiment.

FIG. 7A illustrates an extrusion path 720 of constant radial distance, in accordance with one embodiment. Print head 324 follows extrusion path 720. A nozzle cross-section 327 is associated with print head 324 and generally characterizes the cross-section of an extruded filament.

FIG. 7B illustrates an extruded filament 710 along an extrusion path of constant radial distance, in accordance with one embodiment.

FIG. 7C illustrates extrusion paths 340(0), 340(1) for different extruded filament sizes along corresponding paths of constant radial distance, in accordance with one embodiment. As shown, print head 324(0) follows extrusion path 720(0), while print head 324(1) follows extrusion path 720(1). Nozzle cross-section 327(0), associated with print head 324(0) is smaller in diameter than nozzle cross-section 327(1), associated with print head 324(1). Certain embodiments may include print heads 324 having different nozzle cross-sections 327.

FIG. 7D illustrates extruded filaments 710 of different extruded filament sizes along extrusion paths 720 of constant radial distance, in accordance with one embodiment. As shown extruded filament 710(0) is larger in cross-section than extruded filament 710(1). Consideration should be given to cross-section differences to avoid collisions between a previously extruded filament and print head components, such as nozzle components.

FIG. 7E illustrates a multi-line extrusion nozzle 736 in different angular positions, in accordance with one embodiment. The multi-line extrusion nozzle 736 is configured to rotationally articulate through an extrusion angle, defined herein to be a. As shown, the multi-line extrusion nozzle 736 includes three extrusion openings 737 through which filament material is extruded. In other embodiments, the multi-line extrusion nozzle 736 includes two, four, or any number more than four extrusion openings. In one embodiment, each extrusion opening is defined by a substantially identical cross-section.

In one embodiment, as the multi-line extrusion nozzle 736 moves with respect to constant radius arcs 740, extrusion angle α is adjusted to maintain a constant line-to-line spacing of extruded material. For example, if a print head comprising multi-line extrusion nozzle 736 moves along an R axis from r0 to r1, then the multi-line extrusion nozzle 736 needs to accordingly rotate the extrusion angle from α0 to α1.

In one embodiment, extrusion openings 737 are separated from each other by a gap (as shown). However, extruded filament material should be deposited without such a gap. Therefore, the extrusion angle α should be computed to deposit extruded filament material without a gap. Persons skilled in the art will recognize that the extrusion angle α is a function of specific implementation geometry, but is dependent on at least the geometry of the extrusion openings 737. When the multi-line extrusion nozzle moves along an effective radius coordinate R that does not intersect a rotational origin of an associated print stage, the extrusion angle α may also depend on the effective radius coordinate R.

FIG. 7F illustrates an extruded filament 752 along a linear extrusion path 750, in accordance with one embodiment. The extrusion path 750 specifies a straight line as a function of extrusion time using a radius dimension and an angle dimension within a cylindrical coordinate system. For example, functions for R(t) and θ(t) may be specified to yield a straight line corresponding to extrusion path 750.

While a straight line is illustrated above, arbitrary extrusion paths may be specified as cylindrical coordinate functions in time {R(t) and θ(t)}. Multiple, independently operating print heads may specify independent cylindrical coordinate functions, however θ(t) should be common to each set of cylindrical coordinate functions because the multiple print heads share a common print stage with a common rotational angle. Each independently operating print head should also compute an extrusion rate function e(t), based on travel velocity, which is a function of {R(t) and θ(t)}.

FIG. 8 illustrates a color extruder assembly 800 comprising a color extrusion head 830, in accordance with one embodiment, in accordance with one embodiment. The color extruder assembly 800 includes one or more heat sinks 620 coupled to a color extrusion head 830 through a thermal break 622(2). Thermal breaks 622 separate the heat sinks 620 from each other and from other system elements.

In one embodiment, the color extrusion head 830 includes a heating element 632, a heat conducting spring washer 634, and a nozzle tip 636. In one embodiment, heating element 632 comprises a circular heating element configured to pass filament material through a flow hole, as illustrated above in FIGS. 6B and 6C. In certain implementations, nozzle tip 636 corresponds to nozzle 326 of FIG. 3A.

During deposition, filaments 820 are pushed through thermal breaks 622, heat sinks 620, and the color extrusion head 830 to form extruded filament 812. One design goal of extruder assembly 800 is to generate a monotonic thermal gradient that starts with the heating element 632 and declines in the opposite direction of filament movement. In this way, filaments 820 remain at substantially ambient temperature and are able to maintain structural integrity while being pushed into the color extruder assembly 800, where increasing temperatures ultimately melt the filaments 820 for deposition.

In one embodiment, the color extruder assembly 800 is fed five different filaments 820(1)-820(5), with corresponding colors of white, cyan, magenta, yellow, and black. Relative feed rates for the different filaments 820(1)-820(5) determines a final color for the extruded filament 812. In another embodiment, black is omitted from the different filaments 820, and only four different colors of filament are fed into the color extruder assembly 800. In one embodiment, a mixing chamber 832 is configured to mix the different filaments 820(1)-820(5).

In one embodiment, color for the extruded filament 812 is determined by a ratio of feed rates for filaments 820. The ratio of feed rates is then scaled to correspond to a net extrusion rate function, which depends on net deposition rate for the extruded filament 812. The net extrusion rate may be computed as a function of velocity of the color extruder assembly 800 relative to a print stage such as print stage 314 of FIG. 3A.

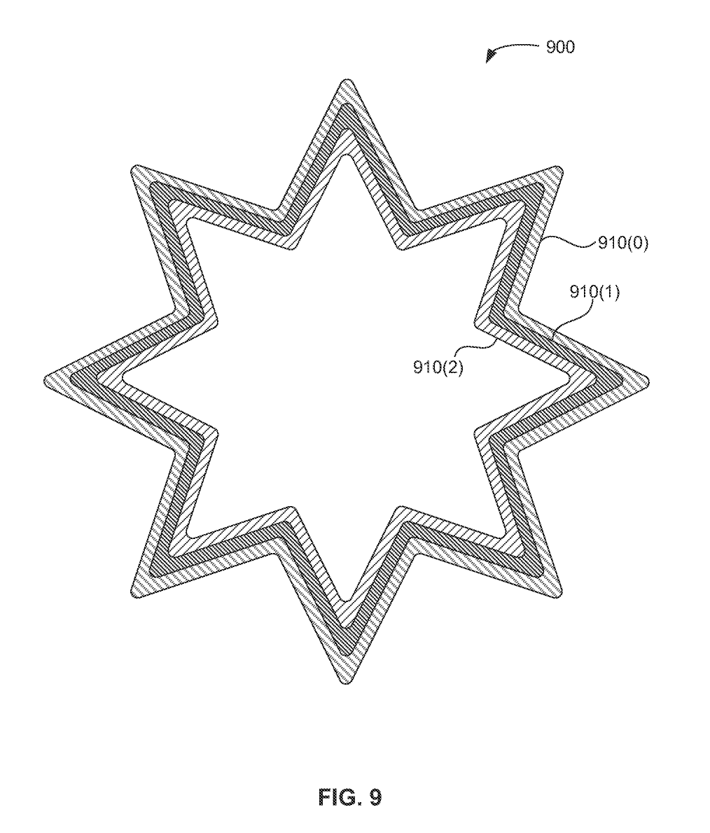

FIG. 9 illustrates a printed layer comprising three different filament materials 910, in accordance with one embodiment. The different filament materials 910 are shown shaded in corresponding different hash patterns. The different filament materials 910 may comprise substantially identical filament materials, substantially identical filament materials with different pigment additives, or substantially different filament materials with certain common material properties, such as common thermal expansion coefficients. Efficient extrusion paths for the different filament materials 910 may be defined by an effective radius function for corresponding print heads that depends on rotation angle θ for a print stage. However, extrusion paths for depositing the different materials may be arbitrarily defined so long as each layer of geometry for a corresponding 3D object are appropriately filled.

In certain embodiments, the 3D printer includes a computing subsystem configured to control overall operation of the 3D printer. In such an embodiment, the computing subsystem is configured to perform methods 100, 120, 140, and 160 of FIGS. 1A, 1B, 1C, and 1D, respectively. In one embodiment, the computing subsystem includes non-transitory, non-volatile computer readable medium configured to store instructions that, when executed by the computing subsystem perform at least one of methods 100, 120, 140, and 160. The computing subsystem may include a processor unit, a non-transitory, non-volatile memory subsystem, and any technically feasible control subsystems configured to operate the various actuators associated with the 3D printer. The computing subsystem may also include an input/output interface such as a network interface configured to send and receive data to other computing devices, such as to receive extrusion path information from the other computing devices. Examples of non-transitory, non-volatile computer readable medium include flash-memory devices, solid-state drives, magnetic hard drives, solid-state read-only memories, and optical storage media such as CD-ROM and DVD optical discs.

While the foregoing is directed to embodiments of the present invention, other and further embodiments of the invention may be devised without departing from the basic scope thereof, and the scope thereof is determined by the claims that follow.

I claim:

1. A method for controlling filament extrusion, comprising:
receiving extrusion path signals that specify a first extrusion path and a second extrusion path for simultaneous execution by a corresponding first print head and second print head; and
simultaneously extruding a first filament from the first print head according to the first extrusion path and a first extrusion rate specification, and a second filament from the second print head according to the second extrusion path and a second extrusion rate specification,
wherein the first extrusion path and the second extrusion path are specified according to a target coordinate space.

2. The method of claim 1, further comprising receiving extrusion rate signals that encode the first extrusion rate specification and the second extrusion rate specification.

3. The method of claim 1, further comprising calculating the first extrusion rate specification and the second extrusion rate specification based on the extrusion path signals.

4. The method of claim 3, wherein calculating the first extrusion rate specification comprises calculating a velocity for the first extrusion path.

5. The method of claim 1, wherein the target coordinate space comprises a cylindrical coordinate system defined to include a height dimension, a radius dimension, and a rotation angle dimension.

6. The method of claim 1, wherein the extrusion path signals comprise digitally-encoded position information.

7. The method of claim 1, wherein the extrusion path signals comprise control signals that directly control position actuators.

8. The method of claim 1, wherein the first extrusion path specifies a first radius function with respect to a rotation angle and the second extrusion path specifies a second radius function with respect to the rotation angle.

9. The method of claim 1, wherein the first filament comprises a first material and the second filament comprises a second, different material.

10. The method of claim 1, wherein the first print head and the second print head are coupled to a common linear track, and wherein the first print head and the second print head are configured to move independently along a common travel path defined by the common linear track.

11. The method of claim 1, wherein the first print head and the second print head are coupled to a common linear track, and wherein the first print head and the second print head are configured to move independently along respective different travel paths defined by the common linear track.

12. The method of claim 1, wherein the first print head is coupled to a first height actuator configured to position the first print head a first height above a print stage and the second print head is coupled to a second height actuator configured to position the second print head a second height above the print stage.

13. The method of claim 12, wherein the first height is substantially equal to the second height and the first extrusion path and the second extrusion path are disposed within a common print layer.

14. The method of claim 1, wherein the first print head includes a first extruder assembly comprising a circular heating element, a spring washer, a nozzle tip, at least one heat sink, and at least one thermal break, wherein the first filament passes through each element of the first extruder assembly.

15. The method of claim 1, wherein the first print head includes first nozzle having a first cross-section and a second nozzle having a second, different cross section.

16. The method of claim 1, wherein the first print head includes a multi-line nozzle having at least two extrusion openings.

17. The method of claim 1, wherein the first print head includes a multi-line nozzle configured to rotate according to an extrusion angle.

18. The method of claim 1, wherein the first print head includes a mixing chamber, and the first filament comprises a blend of at least two different filament colors.

19. A three-dimensional (3D) printer comprising:
a print stage configured to rotate according to an angle dimension;
one or more height actuators coupled to the print stage and configured to establish a position along a height dimension; and
a print head platform coupled to the one or more height actuators and comprising a first print head and a second print head, wherein the first print head is configured to move independently along a first travel path according to a first radius dimension and the second print head is configured to move independently along a second travel path according to a second radius dimension.

20. The 3D printer of claim 19, configured to perform the steps of:
receiving extrusion path signals that specify a first extrusion path and a second extrusion path for simultaneous execution by the first print head and second print head, respectively; and
simultaneously extruding a first filament from the first print head according to the first extrusion path and a first extrusion rate specification, and a second filament from the second print head according to the second extrusion path and a second extrusion rate specification,
wherein the first extrusion path and the second extrusion path are specified according to a cylindrical coordinate space associated with the angle dimension, the height dimension, the first radius dimension, and the second radius dimension.
